(19) United States
(12) Patent Application Publication
(10) Pub. No.: US 2002/0011806 A1
(43) Pub. Date: Jan. 31, 2002

(54) Ballast circuit with independent lamp control

(76) Inventor: Mihail S. Moisin, Brookline, MA (US)

Correspondence Address: NUTTER MCCLENNEN & FISH LLP, ONE INTERNATIONAL PLACE, BOSTON, MA, 02110, US

(21) Appl. No.: 09/790,388

(22) Filed: Feb. 21, 2001

Related U.S. Application Data
(60) Provisional application No. 60/184,889, filed on Feb. 25, 2000.

(51) Int. Cl. H05B 37/02

(52) U.S. Cl. 315/291; 315/224

(57) ABSTRACT

The present invention provides a ballast circuit that allows independent control over a plurity of lamps. In one embodiment, the ballast circuit receives power from two independent AC sources to independently energize two lamps. The ballast circuit includes a rectifier that receives input AC signals from the independent AC sources and applies a DC voltage to an inverter. The inverter in turn can apply an AC voltage to the lamps. The ballast further includes two bias circuits, each of which permits the application of the inverter AC signal to one of the lamps when one input AC signal is present and inhibits the application of the inverter AC signal to that lamp when the input AC signal is not present.

### CROSS REFERENCE TO RELATED APPLICATIONS

The present application claims priority to the provisional application having a Ser. No. 60/184,889, filed on Feb. 25, 2000, and herein incorporated by reference.

### BACKGROUND OF THE INVENTION

The present invention relates generally to electronic ballast circuits, and more particularly, to ballast circuits that can be utilized to independently energize a plurality of loads, such as fluorescent lamps.

There are many types of ballast circuits for energizing devices that emit visible light, such as fluorescent lamps. A so-called electronic ballast receives a relatively low frequency AC (Alternating Current) input signal and provides a relatively high frequency AC output signal to one or more lamps. Typically, the low frequency input signal corresponds to a standard 110 volt, 60 Hz signal which is selectively applied to the ballast by, for example, a conventional wall switch. The high frequency AC output signal provided by the ballast circuit can be, for example, of the order of tens of kilo hertz.

One type of electronic ballast includes a rectifier which receives an AC input signal and provides a DC (Direct Current) signal to an inverter. The inverter can be a resonant inverter which provides a relatively high frequency AC signal to the lamps at operational voltage and current levels which cause the lamps to emit light.

Generally, the ballast is coupled to a source of AC energy via a switch, for example a conventional wall switch, which controls the flow of energy to the ballast for turning the lamps on and off. That is, when the switch is set to an on position the AC signal is applied to the ballast which energizes the lamps such that they emit light. And when the switch is set to an off position, the AC signal is not applied to the ballast and the lamps do not emit light. However, conventional ballasts are not adapted for coupling to more than one AC input signal and do not provide independent control over multiple lamps coupled to the ballast.

Thus, a need exists to provide a ballast circuit adapted for receiving more than one AC input signal and for independently controlling a plurality of lamps coupled to the ballast.

### SUMMARY OF THE INVENTION

The present invention provides a ballast circuit that allows independent control over a plurality of lamps. Although the invention is primarily shown and described as a ballast circuit for energizing a lamp, it should be understood that the invention has other applications as well, such as motor control circuits and voltage regulators.

In one aspect, the invention provides a ballast circuit that receives power from two independent AC sources to independently energize first and second lamps. The ballast circuit includes a rectifier that receives input AC signals from the independent AC sources and applies a DC voltage to an inverter. The inverter in turn provides an output AC signal at a selected frequency to be applied to the lamps. The ballast circuit further includes a first bias circuit connected to one of the independent input AC sources and one of the lamps, e.g., the first lamp, for detecting whether an input AC signal from that AC source is present. The bias circuit permits the application of the inverter AC signal to this lamp when this input AC signal is present, and inhibits the application of the inverter AC signal to the lamp when this input AC signal is not present. This allows selectively energizing one lamp independently of the other.

In a related aspect, a ballast circuit of the invention can include a second bias circuit connected to the other input AC source and to the second lamp. The second bias circuit operates in a manner similar to the first bias circuit. In particular, the second bias circuit detects whether an AC signal from the other input AC source is present. If this AC signal is present, the second bias circuit permits application of the inverter AC signal to the second lamp. Otherwise, it inhibits the application of the second AC signal to the second lamp.

Each bias circuit can include a detector connected to one AC input source to provide a control signal one when that AC input source provides an AC signal. The bias circuit can further include a control circuit that receives the control signal, and permits application of the inverter AC signal to the lamp which is configured to receive power from that AC input source. The detector can be an opto-coupler consisting, for example, of two light emitting diodes coupled in parallel and in opposite polarity, that provides a light signal when the AC input signal is present. The control circuit in turn can include a first switching element, such as an optically coupled transistor, that is activated into a conductive state in response to the light signal to permit the application of the inverter AC signal to the lamp. In some embodiments, the ballast circuit includes a second switching element coupled to the first switching element such that a transition of the first switching element into a conductive state causes a transition of the second switching element into a conductive state. This provides a path for current flow from the inverter to the lamp during at least a portion of the cycle of the inverter AC signal.

In a related aspect, the invention provides a ballast circuit adapted for coupling to first and second independent AC sources to independently energize first and second loads, such as two fluorescent lamps. The ballast circuit can include a rectifier that can couple to first and second independent AC sources to receive first and second AC signals, and to provide a DC output voltage across a positive voltage rail and a negative voltage rail. Two inverter circuits receive input DC power from these positive and negative voltage rails, and each applies an AC output voltage to one load. The ballast circuit further includes two bias circuits, each coupled to one of the AC input sources and one of the inverters. Each bias circuit employs a signal path, extending from the rectifier thereto, to provide a control signal indicating whether an AC signal from one AC source, i.e., the source to which the bias circuit is coupled, is present.

If the AC signal is present, the bias circuit permits the inverter to which it is coupled to energize the respective load. In some embodiments, the inverter circuit includes two switching elements, such as two transistors, and the bias circuit includes a switch coupled one of the inverter switching elements. The switch of the bias circuit transitions from a conductive state to a non-conductive state in response to the bias signal indicating that the AC signal is present. The transition of the switch of the bias circuit activates the switching element of the inverter to which it is coupled, thereby allowing the inverter to apply power to the respective load.

The bias circuit can include a zener diode coupled between signal path and the switch of the bias circuit such that a control signal indicative of the presence of the AC input signal triggers the zener diode, for example by charging up a capacitor connected to the zener diode. The triggering of the zener diode can cause a transition of the switch from a conductive state to a non-conductive state, thereby enabling the inverter.

Another aspect of the invention provides a ballast circuit that can receive power from first and second independent AC sources to independently energize first and second loads. The ballast circuit can include a rectifier adapted to receive first and second AC signals from first and second AC sources, respectively. The rectifier provides a DC output voltage across a positive voltage rail and a negative voltage rail when at least one of the AC input signals is present. The ballast circuit further includes first and second inverter circuits, both of which receive DC power from the rectifier, for energizing the first and second loads, respectively. A first signal path extends from the rectifier to the first control circuit for transmitting the first AC signal thereto. Further, the first control circuit is coupled to the first inverter, and enables the first inverter when the first AC signal is present to energize the load regardless of the presence of the second AC signal.

In a related aspect, the ballast circuit includes a second control circuit coupled to the second inverter circuit, where the second control circuit enables the second inverter when the second AC signal is present to energize the second load regardless of the presence of the first AC signal.

The ballast circuit can include first, second, and third input terminals, where the first and second terminals can be coupled to the first AC source, and the second and third terminals can be coupled to the second AC source. Further, the rectifier can be formed of six diodes, arranged in three parallel groups. Each group includes two diodes coupled end-to-end. The first terminal is coupled to a connection point of two diodes of one group, and the second terminal is coupled to a connection point of two diodes of a second group, and the third terminal is coupled to a connection point of two diodes of a third group.

In yet another aspect, the invention provides a circuit for energizing first and second lamps. The circuit includes first, second, and third input terminals for receiving input AC power from two independent AC sources, where the first and second input terminals receive power from one AC source, and the second and third terminals receive power from the other AC source. The circuit includes two rectifiers, each of which can receive one of the AC input signals to provide a DC voltage. Further, the circuit includes two inverter circuits, each of which receives DC power from one of the rectifiers and applies an AC power to drive one of the lamps. In addition, the circuit includes two inverter disable circuits, each coupled to one of the inverters. Each disable circuit disables its respective inverter when one of the input AC signals is present, and the other one is not.

The ballast circuit can also include two inductively coupled inductors, one of which is coupled to the first input terminal and the other is coupled to the second input terminal. These inductors are also inductively coupled to an inductor of one of the inverter disable circuits such that a flux imbalance in these inductors induces a voltage in the inductor of the disable circuit, which in turn disables the inverter. This flux imbalance is present when no input AC signal exists across the first and second terminals, but an input AC signal exists across the second and third terminals.

### BRIEF DESCRIPTION OF THE DRAWINGS

The invention will be more fully understood from the following detailed description taken in conjunction with the accompanying drawings, in which:

FIG. 1 is a schematic block diagram of a ballast circuit in accordance with the present invention;

FIG. 2 is a schematic block diagram showing further details of the ballast circuit of FIG. 1;

FIG. 3 is a circuit diagram of an exemplary embodiment of the ballast of FIG. 1;

FIG. 4 is a circuit diagram showing further details of the circuit of FIG. 3;

FIG. 5 is a further embodiment of a ballast in accordance with the present invention;

FIG. 6 is a circuit diagram of an exemplary embodiment of the ballast of FIG. 5;

FIG. 7 is a circuit diagram of an alternative embodiment of the ballast of FIG. 5;

FIG. 8 is a schematic diagram of a further embodiment of a ballast in accordance with the present invention;

FIG. 9 is a circuit diagram of an exemplary implementation of the ballast of FIG. 8;

FIG. 10 is a schematic block diagram showing an alternative embodiment of the ballast circuit of FIG. 1;

FIG. 11 is a more detailed diagram of an exemplary implementation of the embodiment of a ballast of FIG. 10 according to the invention;

FIG. 12 is a circuit diagram showing further details of the circuit of FIG. 11; and

FIGS. 12A and 12B are circuit diagrams exemplary implementations of the embodiment of the ballast of FIG. 11 according to the invention.

### DETAILED DESCRIPTION OF THE INVENTION

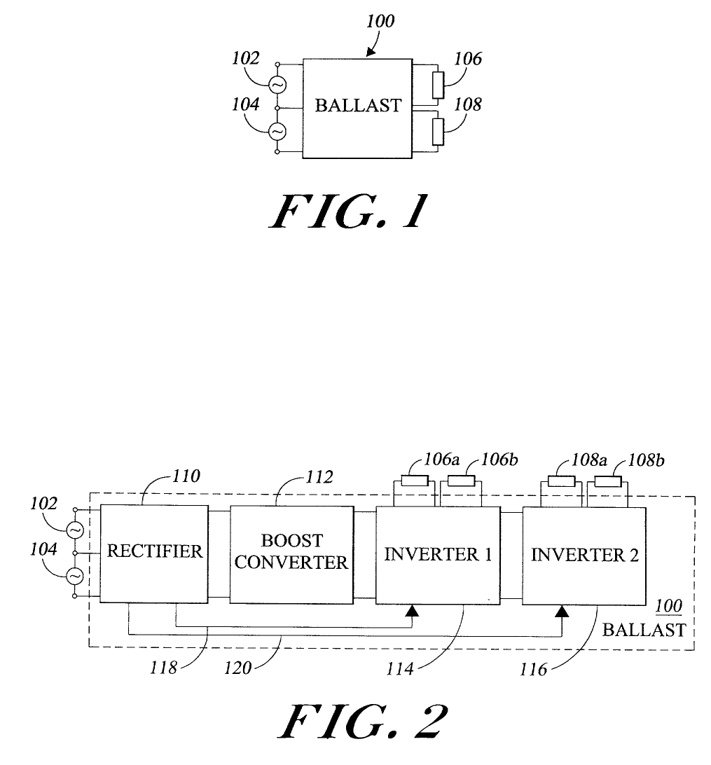

FIG. 1 shows a ballast circuit 100 coupled to first and second AC energy sources 102,104 and to first and second lamps 106,108. The first energy source 102 provides a first AC input signal and the second AC energy source 104 provides a second AC input signal. The first AC input signal enables the ballast to energize the first lamp 106 and the second AC input signal enables the ballast to energize the second lamp 108. As described below, the ballast 100 independently energizes each of the first and second lamps 106,108.

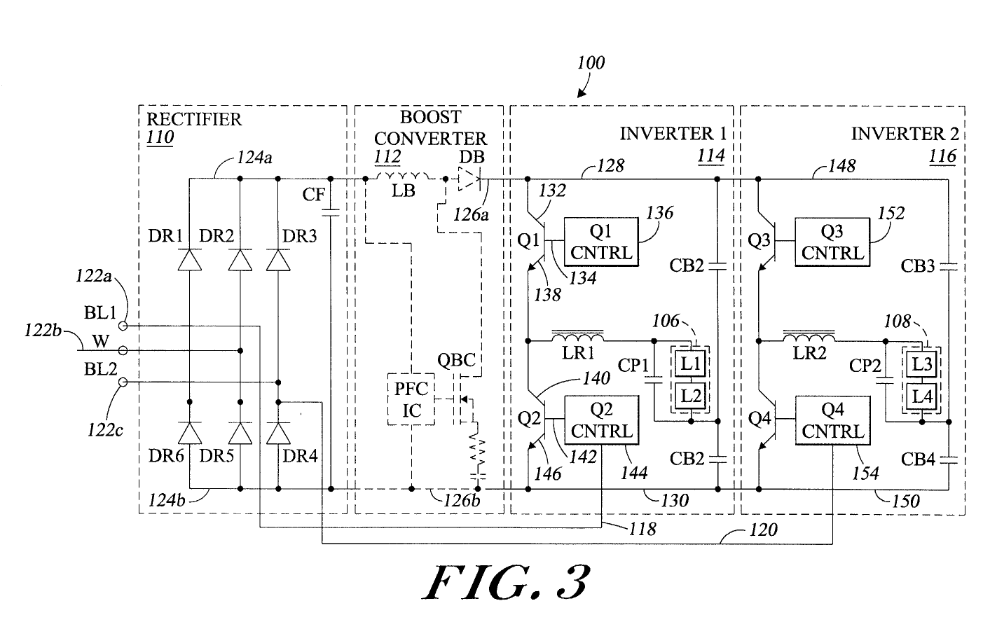

As shown in FIG. 2, the ballast circuit 100 includes a rectifier 110 for receiving the first and second AC input signals and for providing DC energy to a boost converter 112. The boost converter 112 provides DC signal levels to first and second inverters 114,116 which energize first and second pairs of lamps 106a,b,108a,b, respectively. The rectifier 110 also provides a first control signal to the first inverter 114 via a first control signal path 118, and a second control signal to the second inverter 114 via a second control signal path 120. The first control signal 118 is indicative of whether the first AC input signal is present and the second control signal 120 is indicative of whether the second AC input signal is present. The first and second controls signals are effective to selectively enable the inverters to control the flow of energy to the lamps 106,108.

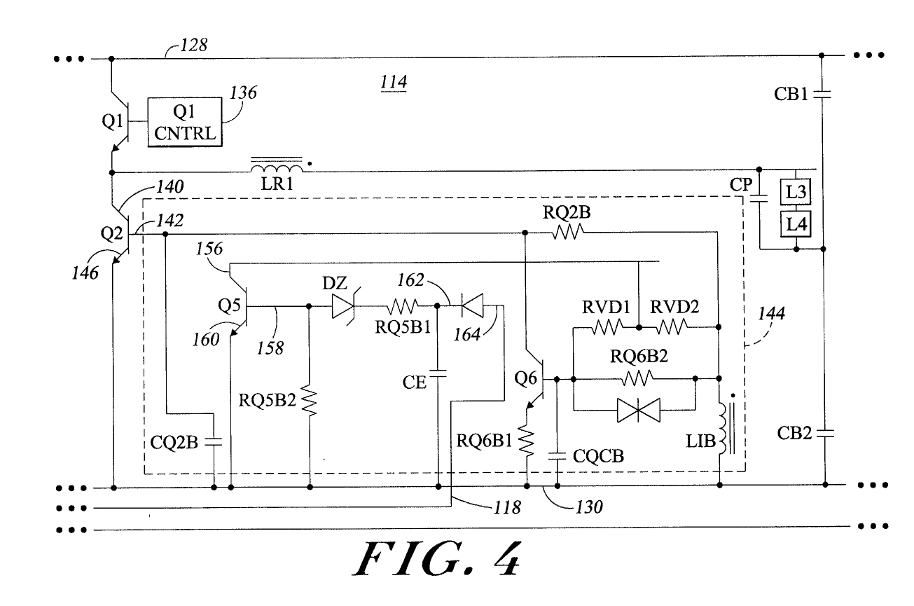

FIG. 3 shows an exemplary circuit implementation of the ballast circuit 100 of FIG. 2, wherein like reference designations indicate like elements. The rectifier 110 includes six rectifying diodes DR1-6 coupled so as to provide first, second, and third AC input terminals 122a,b,c and first and second DC output terminals 124a,b. The first AC input terminal 122a is located between the first and sixth rectifying diodes DR1,DR6, which are coupled end-to-end between the DC output terminals 124a,b. Similarly, the second AC input terminal 122b is located between the second and fifth rectifying diodes DR2,DR5 and the third AC input terminal 122c is located between the third and fourth rectifying diodes DR3,DR4. In an exemplary embodiment, the first AC input terminal 122a is coupled to a first black wire BL1, the second input terminal 122b is coupled to white wire W12, and the third input terminal 122c is coupled to a second black wire BL2. The first AC signal can be provided as a conventional 110 volt, 60 Hz signal transmitted via the first black and white wires BL1,W12 and the second AC signal can also be provided as a 110 volt, 60 Hz signal transmitted via the second black and white wires BL2,W12. It is understood that the white wire W12 can comprise a single wire or a pair of electrically coupled wires, such as, a first white wire corresponding to the first black wire BL1 and a second white wire corresponding to the second black wire BL2.

The DC output terminals 124a,b of the rectifier 110 are coupled to the optional boost converter 112. The boost converter 112 is effective to boost the voltage of the DC signal provided to the inverters 114,116 and to provide power factor correction. Boost converters are well known to one of ordinary skill in the art. In one embodiment shown in phantom, the boost converter 112 includes a power factor correction integrated circuit PFC IC coupled to a FET (field effect transistor) QBC for controlling a conduction state of the FET. The power factor correction integrated circuit can be of the type manufactured by SGS-Thomson Microelectronics of Schaumburg, Ill., U.S.A, and identified as L6560, L6560A, and L6561. The boost converter 112 further includes a boost inductor LB and a diode DB which form a series circuit path from the rectifier output terminal 124a to the first inverter 114. The boost converter 112 includes a first output terminal 126a coupled to a positive rail 128 of the first inverter 114 and a second output terminal 126b coupled to a negative rail 130 of the first inverter.

The first inverter 114 is shown having first and second switching elements Q1,Q2 coupled in a half bridge arrangement. However, it is understood that other inverter configurations are possible, such as full bridge topologies. The first switching element Q1, shown as a transistor, has a collector terminal 132 coupled to the positive rail 128 of the inverter 114, a base terminal 134 coupled to a first or Q1 control circuit 136, and an emitter terminal 138 coupled to the second switching element Q2. The second switching element Q2 has a collector terminal 140 coupled to the emitter terminal 138 of the first switching element Q1, a base terminal 142 coupled to a second or Q2 control circuit 144, and an emitter terminal 146 coupled to the negative rail 130 of the inverter 114. The conduction state of the first switching element Q1 is controlled by the first control circuit 136 and the conduction state of the second switching element Q2 is controlled by the second control circuit 144.

The first inverter 114 further includes a first resonant inductive element LR1 coupled at one end to a point between the switching elements Q1, Q2 and at the other end to a first parallel capacitor CP1. The lamps in the first pair of lamps 106 (first lamp 106a, second lamp 106b) are coupled end-to-end such that the lamps are connected in parallel with the first parallel capacitor CP1. First and second bridge capacitors CB1, CB2 are coupled end-to-end between the positive and negative rails 128,130 of the inverter. The junction of the second lamp 106b and the parallel capacitor CP1 is coupled to a point between the first and second bridge capacitors CB1, CB2.

The second inverter 116 has a configuration that mirrors that of the first inverter 114. Third and fourth switching elements Q3,Q4 are coupled in a half bridge configuration between the positive and negative rails 148,150 of the second inverter 116 with conduction states determined by third and fourth control circuits 152,154 respectively. A resonant circuit is formed by a second resonant inductive element LR2, a second parallel capacitor CP2 and a second pair of lamps 108 (third lamp 108a, fourth lamp 108b). Third and fourth bridge capacitors CB3,CB4 are coupled end-to-end across the rails 148,150 of the second inverter 116 with a lamp current path connected to a point between the bridge capacitors CB3,CB4.

The first control path 118, which provides a signal path for the first control signal, extends from the first input terminal 122a of the rectifier 110 to the second control circuit 144. The second control path 120, which provides a signal path for the second control signal, extends from the third input terminal 122c to the fourth control circuit 154. The first control signal indicates whether the first AC input signal (on wires BL1,W12) is being applied to the first and second input terminals 122a,b of the rectifier. And the second control signal indicates whether the second AC input signal (on wires BL2,W12) is present on the second and third terminals 122b,c of the rectifier. The first and second control signals provide independent control over the first and second inverters 114,116. That is, the first inverter 114 can energize the first pair of lamps 106 when the first AC input signal is present. And the second inverter 116 can energize the second pair of lamps 108 when the second AC signal is present.

In operation, the first and second inverters 114,116 each operate at or about a characteristic resonant frequency which is determined by the impedances of the various circuit elements, such as the respective resonant inductive elements, LR1,LR2, parallel capacitors CP1,CP2 and lamps 106,108. For the first inverter 114, current through the lamps 106 flows in a first direction while the first switching element Q1 is conductive and in a second, opposite direction when the second switching element Q2 is conductive. The current periodically reverses direction as determined by the resonant frequency of the circuit. The first and second control circuits 136,144 control the respective conduction states of the first and second switching elements Q1,Q2 to facilitate resonant operation of the circuit.

When the first AC input signal is applied to the rectifier 110, the first control signal, via the first control path 118, enables the second control circuit 144 to bias the second switching element to a conductive state. Thus, when the first AC signal is present, the first inverter 114 is enabled to resonate such that the ballast circuit energizes the first pair of lamps 106 with AC energy which causes the lamps to emit light.

When the first AC signal is not present at the rectifier 110, the first control signal conveys this information to the second control circuit 144 which prevents the second switching element Q2 from transitioning to a conductive state. Thus, the first inverter 114 cannot resonate and is thereby disabled when the first AC signal is not applied to the rectifier 110. With the first inverter disabled, the first pair of lamps 106 is not energized.

Similarly, when the second AC input signal is present at the rectifier 110, the second control signal, via the second control path 120, enables the fourth control circuit 154 to bias the fourth switching element Q4 to a conductive state for resonant operation of the second inverter 116. And when the second AC input signal is not present, the fourth control circuit 154 prevents the fourth switching element Q4 from turning on, thereby disabling the second inverter 116.

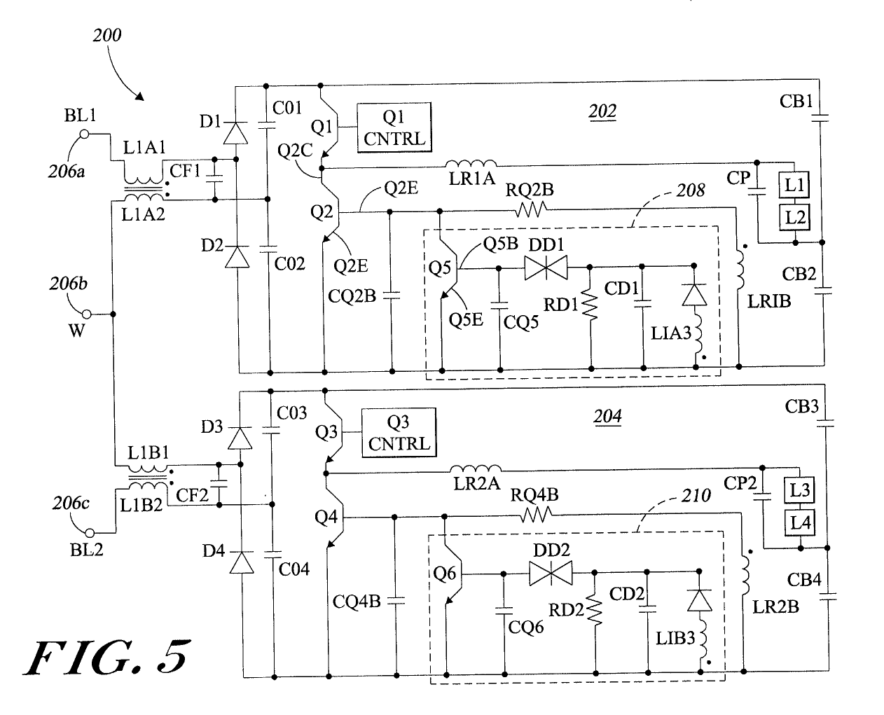

FIG. 4 shows an exemplary embodiment of the second control circuit 144 of FIG. 3, wherein like reference designations indicate like elements. The second control circuit 144 includes fifth and sixth switching elements Q5,Q6 that are effective to enable the second switching element Q2 to transition to a conductive state when the first AC signal is present on the first control path 118. In general, when the fifth switching element Q5 is conductive (i.e., the first AC signal is present) the second switching element Q2 can transition to a conductive state to achieve resonant operation of the first inverter 114. And when the fifth switching element Q5 is not conductive (i.e., the first AC signal is not present), the sixth switching element Q6 transitions to a conductive state which prevents the second switching element Q2 from transitioning to a conductive state, thereby disabling the first inverter 114.

It is understood that a control path indicating the presence of an AC signal at the rectifier can be coupled to either or both of the first and second control circuits 136,144. It is further understood that the second control path 120 is coupled to the second inverter 116 (FIG. 3) for selectively enabling the third and/or fourth switching elements Q3,Q4.

In the exemplary embodiment of FIG. 4, the second control circuit 144 includes a first capacitor CQ2B coupled at one terminal to the base terminal 142 of the second switching element Q2 and at the other terminal to the negative rail 130 of the first inverter. A first resistor RQ2B and inductive bias element L1B provide a series circuit path from the base terminal 142 of the switching element Q2 to the negative rail 130. The bias element L1B is inductively coupled to the first resonant inductive element L1R such that current flow through the first resonant inductive element L1R induces a corresponding voltage in the bias element L1B which biases the base terminal 142 of the second switching element Q2. As known to one of ordinary skill in the art, as current flow through the first resonant inductive element L1R periodically reverses direction due to resonance of the circuit, the corresponding voltage induced at the bias element L1B is effective to alternately bias the second switching element Q2 to conductive and nonconductive states.

The fifth switching element Q5, shown as a transistor, has a collector terminal 156 coupled to a point between first and second voltage dividing resistors RDV1,RVD2, a base terminal 158, and an emitter terminal 160. A zener diode DZ, a second resistor RQ5B1 and an enable capacitor CE provide a series circuit path from the base terminal 158 of the fifth switching element Q5 to the negative rail 130 of the first inverter 114. A third resistor RQ5B2 is coupled between the base terminal 158 and the negative rail 130. An enable diode DE has a cathode 162 coupled to the enable capacitor CE and an anode 164 coupled to the first control path 118 which extends to a point between the first and sixth diodes DR1,DR6, i.e., the first AC input terminal 122a of the rectifier 110 (FIG. 3).

The sixth switching element Q6 has a collector terminal 166 coupled to the base terminal 142 of the second switching element Q2, a base terminal 168 coupled to an RC network, and an emitter terminal 170 coupled to the negative rail 130 via a resistor RQ6B1. A capacitor CQ6B is coupled between the base terminal 168 and the negative rail 130. A first series circuit path extends from the base terminal 168 through the first and second voltage resistors RVD1,RVD2, and the bias element L1B to the negative rail 130. A second series circuit path extends from the base terminal 168 through a resistor RQ6B2 and the bias element L1B to the negative rail 130. A diac DD1 is coupled at one terminal to the base terminal 168 and at the other terminal to the bias element L1B.

Referring now to FIG. 4 in combination with FIG. 3, when the first AC input signal, via the first black and white wires BL1,W12, is applied to the first and second input terminals 122a,b of the rectifier 110, the first control signal path 118 provides this AC signal to the second control circuit 144. The AC signal is rectified by the enable diode DE and the enable capacitor CE is charged to a predetermined voltage level. When the enable capacitor CE is charged to level greater than a voltage threshold associated with the zener diode DZ, the base of the fifth switching element Q5 is biased with a positive potential that is effective to transition Q5 to a conductive state. And when Q5 is conductive, the sixth switching element Q6 is prevented from transitioning to a conductive state. The sixth switching element Q6, when it is in the conductive state, effectively shorts the second switching element Q2 thereby disabling the first inverter 114. The sixth switching element Q6 can become conductive during operation of the circuit unless the fifth switching element Q5 is turned on by the first AC signal.

The ballast circuit 100 can be coupled to remotely located first and second wall switches which independently control the flow of respective first and second AC signals to the ballast. The ballast independently enables the flow of energy to respective first and second lamps connected to the ballast. The ballast energizes the first lamp when the first AC signal is present and energizes the second lamp when the second AC signal is present. Thus, a single ballast receives first and second AC input signals each of which is effective to energize a respective one of the first and second lamps.

It may be required that two lamps of a light fixture having four lamps be turned on independently of the other two. To fulfill this requirement, a typical conventional configuration includes a first ballast coupled to a first wall switch and a first pair of lamps and a second ballast coupled to a second wall switch and a second pair of lamps. The first wall switch controls the first pair of lamps and the second wall switch controls the second pair of lamps.

In contrast, a ballast 100 in accordance with the present invention can independently energize two sets of lamps housed in a single light fixture. In one embodiment, a first wall switch, which is coupled to the ballast 100, controls a first pair of lamps and a second wall switch, which is also coupled to the ballast 100, controls a second pair of lamps. Thus, a single ballast 100 independently energizes first and second pairs of lamps housed in a four lamp light fixture.

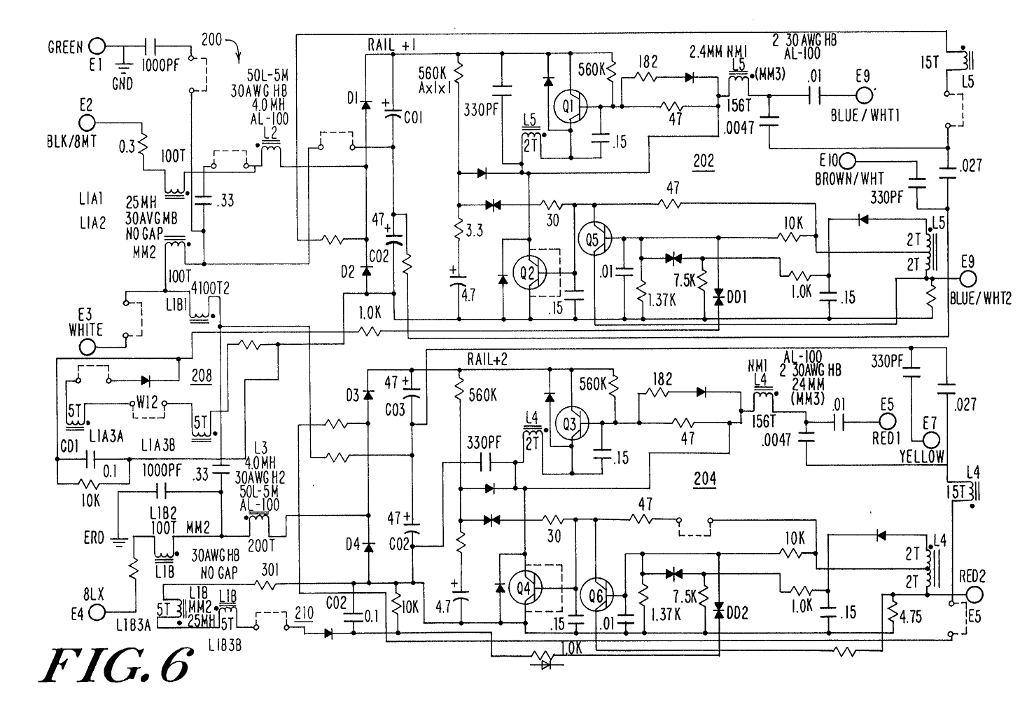

FIG. 5 shows an alternative embodiment of a ballast 200 having a dual inverter configuration providing independent control over a plurality of lamps. The first inverter 202 can have a half-bridge configuration formed from first and second switching elements Q1,Q2, and the second half-bridge inverter 204 can include third and fourth switching elements Q3,Q4. The first and second inverters 202,204 are independently controlled by a first AC input signal on first and second AC input terminals 206a,b, e.g., first black wire BL1 and a white wire W, and a second AC input signal on the second terminal 206b and a third AC input terminal 206c, e.g., the white wire W and a second black wire BL2. The first inverter 202 is disabled by a first inverter disable circuit 208 when the first AC input signal is not present and the second AC input signal is present. Similarly, the second inverter 204 is disabled by a second inverter disable circuit 210 when the first AC input signal is present and the second AC input signal is not present.

In one embodiment, a first inductor L1A1 is coupled to the first AC input terminal 206a and a second inductor L1A2, which is inductively coupled to the first inductor L1A1, is coupled to the second AC input terminal 206b. A third inductor L1A3, which is inductively coupled to the first and second inductors L1A1,L1A2, forms a part of the first inverter disable circuit 208. The first inverter disable circuit 208 can further include a capacitor CD1 and a first diac DD1 coupled to the base terminal Q5B of a transistor Q5, which has a collector terminal Q5C coupled to the base terminal Q2B of the second switching element Q2 of the first inverter 202.

Similarly, a fourth inductor L1B1 is coupled to the second AC input terminal 206b, a fifth inductor L1B2 is coupled to the third AC input terminal 206c, and a sixth inductor L1B3, which forms part of a second inverter disable circuit 210, is coupled to a sixth switching element Q6 for controlling a switching transistor Q4 of the second inverter 204. The second inverter disable circuit can further include a capacitor CD2 and a second diac DD2 coupled to the transistor Q6 for selectively disabling the second inverter.

In operation, the magnetic flux generated by each of the first and second inductive elements L1A1,L1A2 cancels the flux generated by the other, when the first AC input signal is present on the first and second terminals. In the case where the second AC input signal is present, and the first AC input signal is not present, the flux generated by the second inductor L1A2 is not canceled such that a voltage is generated on the third inductor L1A3, which charges the capacitor CD1. When the voltage on the capacitor CD1 rises above a predetermined threshold, the first diac DD1 triggers and the fifth switching element Q5 transitions to the conductive state. This effectively prevents the second switching element Q2 of the first inverter from transitioning to a conductive state, thereby disabling the first inverter 202.

Similarly, when the first AC input signal is present and the second AC input signal is not present, a voltage is generated on inductive element L1B3 to disable the second inverter 210.

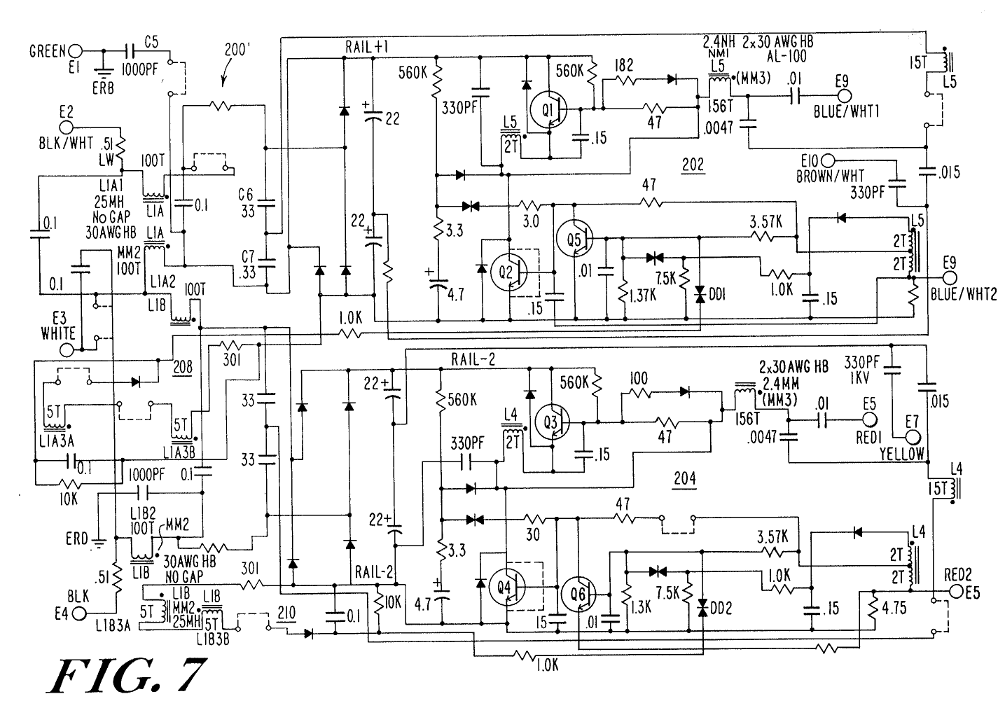

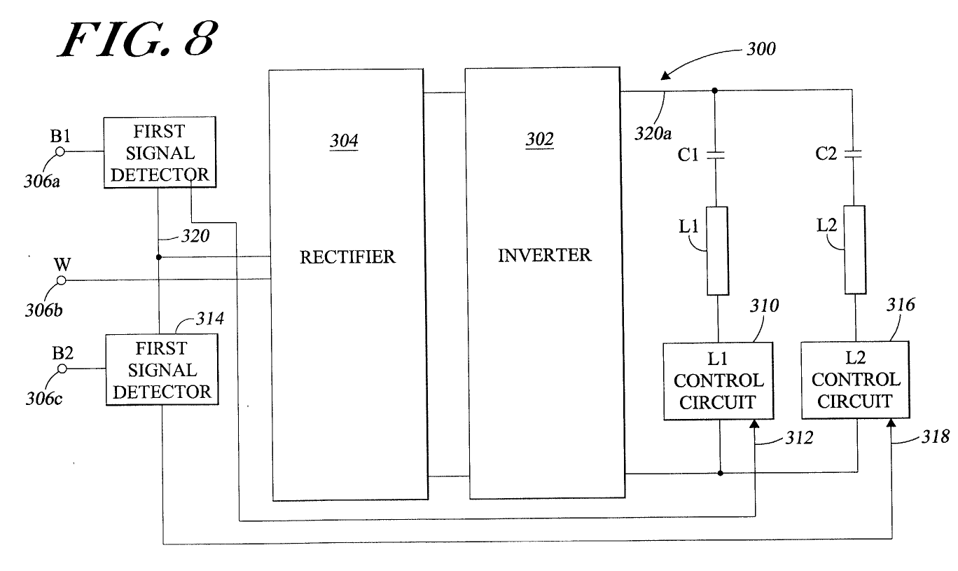

FIG. 6 shows an exemplary detailed circuit implementation of the circuit 200 of FIG. 5 adapted for 120 V operation. FIG. 7 shows a similar circuit implementation adapted for 277 Volt operation. Various other features of these circuits are shown and described, for example, in co-pending and commonly owned U.S. application Sre. Nos. 09/173,850, 09/173,852, and 09/173,966, all filed on Oct. 16, 1998, and all incorporated herein by reference. It should be understood that these circuits are shown only for illustrative purposes, and are not intended to limit the scope of the present invention.

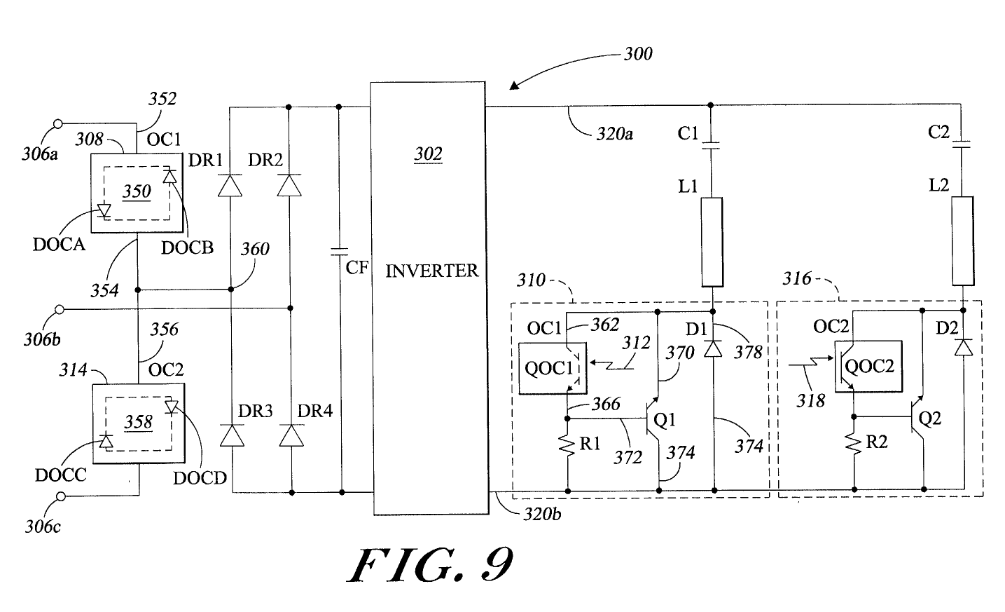

FIG. 8 shows a ballast 300 in accordance with the present invention that independently energizes first and second lamps L1,L2 with a common inverter 302 energized by a rectifier 304. In an exemplary embodiment, the ballast 300 includes a first input terminal 306a for coupling to a first black wire B1 and a second input terminal 306b for coupling to white wire W. A third input terminal 306c and the second input terminal 306b are adapted for coupling to a second black wire B2 and the white wire W, respectively. A first AC input signal corresponds to the first black wire B1 and the white wire W and a second AC input signal corresponds to the second black wire B2 and the white wire W.

A first signal detector 308 is coupled to the first input terminal 306a and to a first lamp control circuit 310 via a first control signal path 312. The first signal detector 308 provides a first control signal to the first lamp control circuit 310 that is indicative of whether the first AC input signal is present. A second signal detector 314 is coupled to the third input terminal 306c and to a second lamp control circuit 316 via a second control signal path 318. The second signal detector 314 provides a second control signal to the second lamp control circuit 316 that is indicative of whether the second AC input signal is present. The first and second signal detectors 308,314 are coupled together at a node 320 that is also connected to the rectifier 304. The second input terminal 306b is also connected to the rectifier 304.

The first lamp L1, a first capacitor C1 and the first lamp control circuit 310 form a first series circuit path and the second lamp L2, a second capacitor C2 and the second lamp control circuit 316 form a second series circuit path. The first and second series circuit paths are coupled across first and second terminals 320a,b of the inverter, which provide a drive signal to the first and second lamps L1,L2.

In one embodiment, the first lamp L1 is coupled between the first capacitor C1, which is coupled to the first inverter terminal 320a, and the first lamp control circuit 310, which is coupled to the second inverter terminal 320b. Similarly, the second lamp L2 can be coupled between a second capacitor C2 and the second lamp control circuit 316.

In operation, the rectifier 304 energizes the inverter 302 when either of the first and second AC input signals is present. When the first AC input signal is present on the first and second terminals 306a,b, the first signal detector 308 sends a “signal present” indication to the first lamp control circuit 310 via the first signal path 312. The first lamp control circuit 310 then enables the flow of current through the first lamp L1. Similarly, when the second AC signal is present on the second and third terminals 306b,c, the second signal detector 314 sends a “signal present” indication to the second lamp control circuit 316, which then enables the second lamp L2 to be energized.

In the case where the first and second AC input signals are both present, the first and second capacitors C1,C2 buffer the high frequency signal from the inverter 302 such that the first lamp to light does not prevent the other lamp from lighting due to excessive current draw by the first lighted lamp.

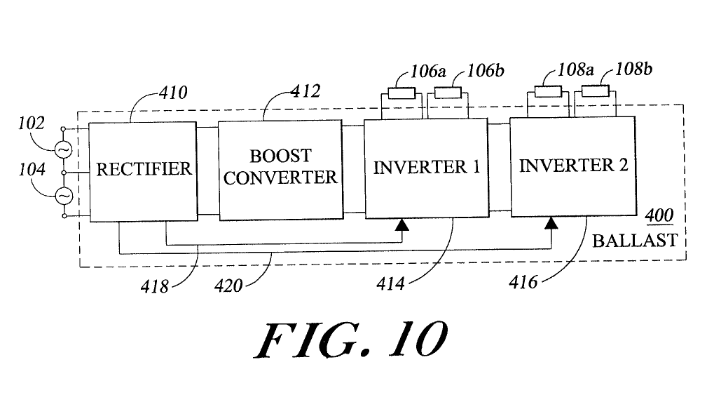

FIG. 9 shows an exemplary circuit implementation of the ballast 300 of FIG. 8. The first signal detector 308 includes a first optocoupler 350 having a first terminal 352 coupled to the first input terminal 306a and a second terminal 354 coupled to the first terminal 356 of a second optocoupler 358, which corresponds to the second signal detector 314. In one embodiment, the first optocoupler 350 includes first and second light emitting diodes DOCA,DOCB coupled in parallel and in opposite polarity. The second optocoupler 358 can include first and second diodes DOCC,DOCD connected in a similar manner.

The rectifier 304 includes diodes DR1-4 coupled in a full bridge configuration as shown. The node 360 formed by the second terminal 354 of the first optocoupler 350 and the first terminal 356 of the second optocoupler 358 is coupled to a point 360 between the first and third rectifier diodes DR1,DR3. The second AC input terminal 306b is coupled to a point between the second and fourth rectifier diodes DR2,DR4.

In one embodiment, the first lamp control circuit 310 includes a first optically coupled transistor QOC1 forming a part of the first optocoupler 350. The transistor QOC1 can include a collector terminal 362 coupled to the first lamp L1, a base terminal 364 optically coupled via a signal path 312 to the first optocoupler diodes DOCA,DOCB, and an emitter terminal 366 coupled to the second terminal 320b of the inverter via a resistor R1. The first lamp control circuit 310 can further include a first control transistor Q1 having a collector terminal 370 connected to the collector terminal 362 of the first optically coupled transistor QOC1, a base terminal 372 coupled to the emitter 366 of transistor QOC1, and an emitter terminal 374 coupled to the second inverter terminal 320b. A first diode D1 includes an anode 376 coupled to the second terminal 320b and a cathode 378 coupled to the first lamp L1 and to the collector terminals of the transistors Q1,QOC1.

The second lamp control circuit 316 can also include a transistor QOC2 optically coupled to the second optocoupler 358 via a signal path 318, a control transistor Q2, and a diode D2, coupled in a manner similar to the first lamp control circuit 310.

When the first AC signal is present, the light emitting diodes (LEDS) DOCA,DOCB will bias the first optically coupled transistor QOC1 to a conductive state, which transitions the first control transistor Q1 to a conductive state. The conductive control transistor Q1 provides a path for current to flow from the first terminal 320a of the inverter to the second terminal 320b and the diode D1 provides a path for current to flow from the second terminal 320b to the first terminal 320a. Thus, the AC signal from the inverter 302 can energize the first lamp L1.

When the first AC signal is not present, the diodes DOCA,DOCB in the first optocoupler 350 are not activated and the first optically coupled transistor QOC1 does not bias the control transistor Q1 to a conductive state. Thus, there is no path for current to flow from the first inverter terminal 320a, thereby disabling the first lamp L1.

Similarly, when the second AC signal is present, the light emitting diodes DOCC,DOCD in the second optocoupler 358 are activated, which biases the second optically coupled transistor QOC2 to a conductive state. This transitions the second control transistor Q2 to the conductive state such that the transistor Q2 and the second diode D2 allow current flow between the first and second inverter terminals 320a,b to energize the second lamp L2.

Thus, the first AC input signal energizes the first lamp L1 independently of whether the second AC input signal is present and the second AC input signal energizes the second lamp L2 independently of whether the first AC signal is present. Hence, the ballast provides independent lamp control with a relatively high degree of circuit component commonality.

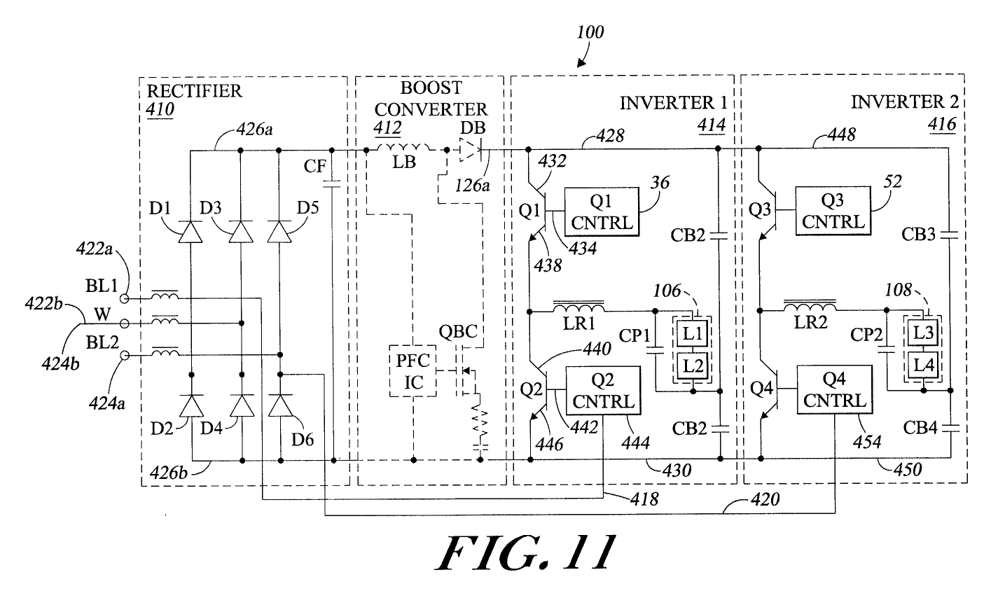

Referring now to FIG. 10, a ballast circuit 400 includes a rectifier 410 for receiving the first and second AC input signals and for providing DC energy to a boost converter 412. The boost converter 412 provides DC signal levels to first and second inverters 414, 416 which energize first and second pairs of lamps 106a,b, and 108a,b, respectively. The rectifier 410 also provides a first control signal to the first inverter 414 via a first control signal path 418, and a second control signal to the second inverter 414 via a second control signal path 420. The first control signal 418 is indicative of whether the first AC input signal is being applied to the rectifier and the second control signal 420 is indicative of whether the second AC input signal is present. The first and second control signals are effective to selectively enable or disable the inverters to control the flow of energy to the lamps 106,108.

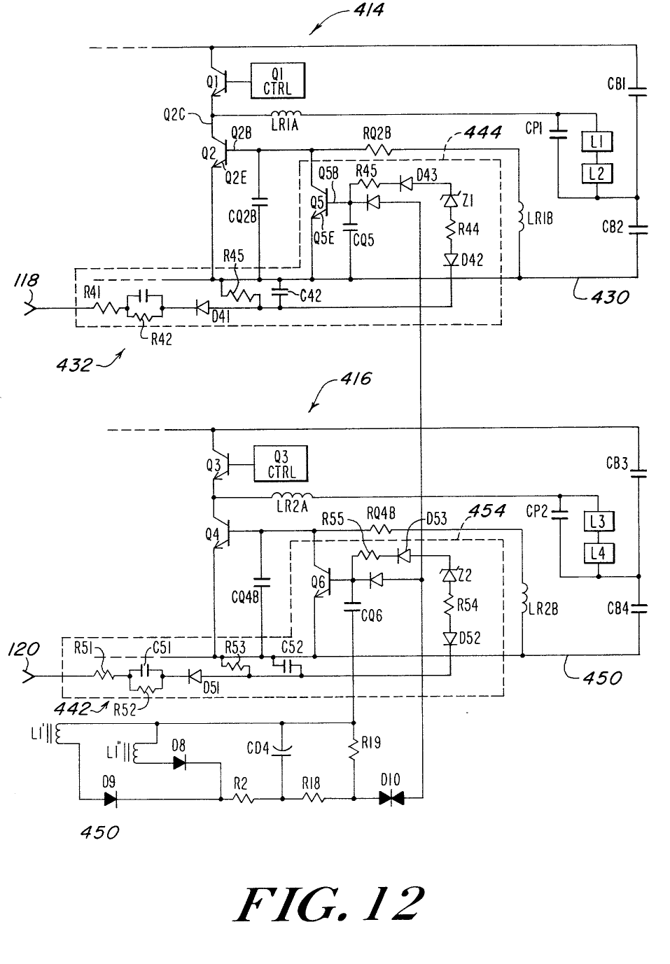

Referring now to FIG. 11, an exemplary circuit implementation of the ballast circuit 400 of FIG. 10 is shown, wherein like reference designations indicate like elements. The rectifier 410 includes six rectifying diodes D1-D6 coupled so as to provide first, second, and third AC input terminals 422a, 422b (which is common to 424b) and 424a and first and second DC output terminals 426a,b. The first AC input terminal 422a is located between the first and second rectifying diodes D1,D2, which are coupled end-to-end between the DC output terminals 426a, b. Similarly, the second AC input terminal 422b (common to input terminal 424b) is located between the third and fourth rectifying diodes D4, D5 and the third AC input terminal 424a is located between the fifth and sixth rectifying diodes D5, D6. In an exemplary embodiment, the first AC input terminal 422a is coupled to a first black wire BL1, the second input terminal 422b is coupled to a white wire W1 and a white wire W2, and the third input terminal 424a is coupled to a second black wire BL2. The first AC signal can be provided as a conventional 110 volt, 60 Hz signal transmitted via the first black and white wires BLI, W1 and the second AC signal can also be provided as a 110 volt, 60 Hz signal transmitted via the second black and white wires BL2, W2.

The DC output terminals 426a,b of the rectifier 410 are coupled to the optional boost converter 412. The boost converter 412 is effective to boost the voltage of the DC signal provided to the inverters 414, 416 and to provide power factor correction. Boost converters are well known to one of ordinary skill in the art as described earlier in connection with FIG. 3.

The first inverter 414 is shown having first and second switching elements Q1, Q2 coupled in a half bridge arrangement. However, it is understood that other inverter configurations are possible, such as full bridge topologies. The first switching element Q1, shown as a transistor, has a collector terminal 432 coupled to the positive rail 428 of the inverter 414, a base terminal 434 coupled to a first or Q1 control circuit 436, and an emitter terminal 438 coupled to the second switching element Q2. The second switching element Q2 has a collector terminal 440 coupled to the emitter terminal 438 of the first switching element Q1, a base terminal 442 coupled to a second or Q2 control circuit 444, and an emitter terminal 446 coupled to the negative rail 430 of the inverter 414. The conduction state of the first switching element Q1 is controlled by the first control circuit 436 and the conduction state of the second switching element Q2 is controlled by the second control circuit 444.

The first inverter 414 further includes a first resonant inductive element LR1 coupled at one end to a point between the switching elements Q1, Q2 and at the other end to a first parallel capacitor CP1. The lamps in the first pair of lamps 106 (first lamp 106a, second lamp 106b) are coupled end-to-end such that the lamps are connected in parallel with the first parallel capacitor CP1. First and second bridge capacitors CB1,CB2 are coupled end-to-end between the positive and negative rails 428, 430 of the inverter. The junction of the second lamp 106b and the parallel capacitor CP1 is coupled to a point between the first and second bridge capacitors CB1, CB2.

The second inverter 416 has a configuration that mirrors that of the first inverter 414. Third and fourth switching elements Q3, Q4 are coupled in a half bridge configuration between the positive and negative rails 448, 450 of the second inverter 416 with conduction states determined by third and fourth control circuits 452, 454 respectively. A resonant circuit is formed by a second resonant inductive element LR2, a second parallel capacitor CP2 and the second pair of lamps 108 (third lamp 108a, fourth lamp 108b). Third and fourth bridge capacitors CB3, CB4 are coupled end-to-end across the rails 448, 450 of the second inverter 416 with a lamp current path connected to a point between the bridge capacitors CB3, CB4.

The first control path 418, which provides a signal path for the first control signal, extends from the junction between first and second rectifying diodes D1, D2 to the second control circuit 444. The second control path 420, which provides a signal path for the second control signal, extends from the fifth and sixth rectifying diodes D5, D6 to the fourth control circuit 454. The first control signal is indicative of whether the first AC input signal (on wires BL1, W1) is being applied to the first and second input terminals 422a,b of the rectifier 410. And the second control signal corresponds to whether the second AC input signal (on wires BL2, W2) is present on the terminals 424a,b of the rectifier 410. The first and second control signals provide independent control over the first and second inverters 414, 416. That is, the first inverter 414 can energize the first pair of lamps 106 when the first AC input signal is present and the second inverter 416 can energize the second pair of lamps 108 when the second AC signal is present.

In operation, each of the first and second inverters 414, 416 operates at or about a characteristic resonant frequency which is determined by the impedances of the various circuit elements, such as the respective resonant inductive elements, LR1, LR2, parallel capacitors CP1,CP2 and lamps 106,108. For the first inverter 414, current through the lamps 106 flows in a first direction while the first switching element Q1 is conductive and in a second, opposite direction when the second switching element Q2 is conductive. The current periodically reverses direction as determined by the resonant frequency of the circuit. The first and second control circuits 436, 444 control the respective conduction states of the first and second switching elements Q1, Q2 to facilitate resonant operation of the circuit.

When the first AC input signal is applied to the rectifier 410, the first control signal, via the first control path 418, enables the second control circuit 444 to bias the second switching element to the conductive state. Thus, when the first AC signal is present the first inverter 414 is enabled to resonate such that the ballast energizes the first pair of lamps 106 with AC energy which causes the lamps to emit light.

When the first AC signal is not present at the rectifier 410, the first control signal conveys this information to the second control circuit 444 which prevents the second switching element Q2 from transitioning to a conductive state. Thus, the first inverter 414 cannot resonate and is thereby disabled when the first AC signal is not applied to the rectifier 410. With the first inverter disabled, the first pair of lamps 106 is not energized.

Similarly, when the second AC input signal is present at the rectifier 410, the second control signal, via the second control path 420, enables the fourth control circuit 454 to bias the fourth switching element Q4 to a conductive state for resonant operation of the second inverter 416. And when the second AC input signal is not present, the fourth control circuit 454 prevents the turning on of the fourth switching element Q4, thereby disabling the second inverter 416.

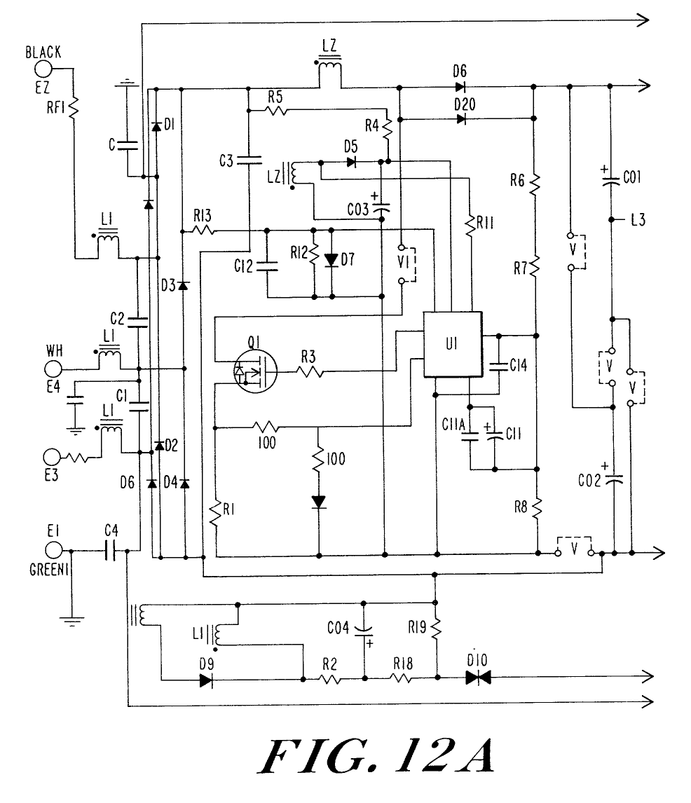

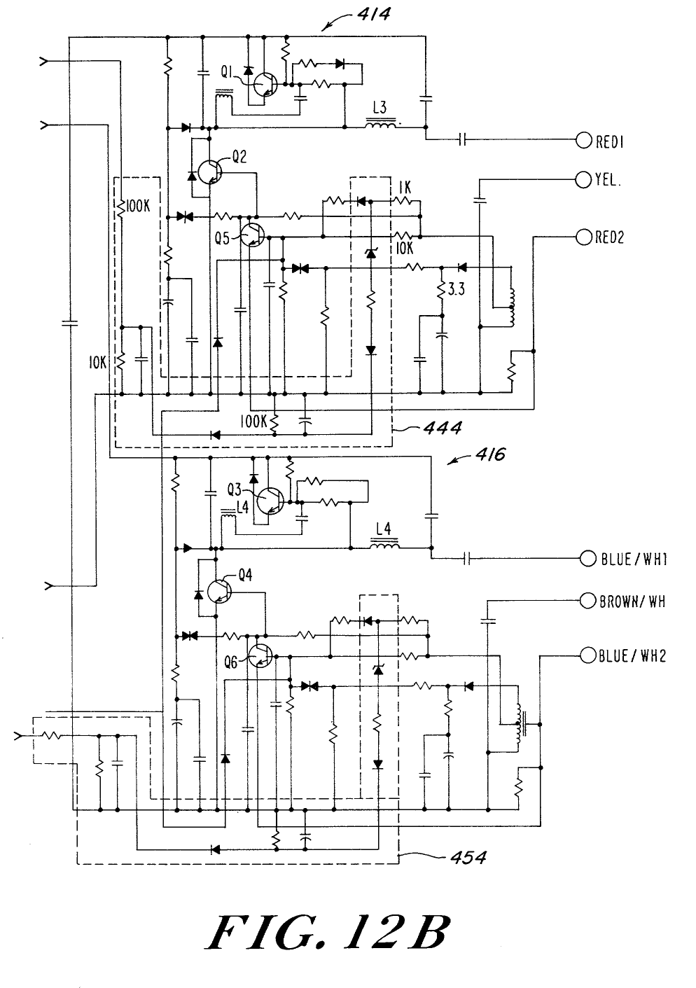

Referring now to FIG. 12, the first inverter 414 is enabled by the control circuit 444 when the first AC input signal is present. Similarly, the second inverter 416 is enabled by a control circuit 454 when the second AC input signal is present.

The control circuit 444 is shown to include a resistor R41, a capacitor C41 and resistor R42 pair, a diode D41, a resistor R43, a capacitor C42, a diode D42, a resistor R44, a zener diode Z1, a diode D43 and a resistor R45. The resisters R41, R42 and R43 provide a voltage divider network 432 with diode D41 between the negative rail 430 and the junction between rectifying diodes D1 and D2 of the rectifier 410. The capacitor C41 in conjunction with resistor R42 provides a high frequency filter. The capacitor C42 is in parallel with resistor R43 and when an AC signal is present at first AC input terminal 422a, diode D41 allows current to flow from the negative rail to the junction between diodes D1 and D2 of the rectifier which in turn provides a negative voltage on capacitor C42 at the junction of the capacitor C42 and diode D41.

The junction between the capacitor C42 and diode D41 is connected in series with the diode D42, the resistor R44, the zener diode Z1, the diode D43 and the resistor R45 to the base of transistor Q5. In operation, when the negative voltage on the capacitor C42 rises above a predetermined threshold, the zener diode Z1 triggers and the switching element Q5 transitions to a non-conductive state. This effectively enables the second switching element Q2 of the first inverter to transition to a conductive state, thereby enabling the first inverter 414.

It should be appreciated that the zener diode Z1 is effective to provide a reference voltage to the gate of the switching element or transisitor Q5 to turn off transistor Q5 to ensure that the inverter 414 is enabled.

It should be noted in this embodiment in operation a circuit 450 includes a capacitor CD4 and a diac D10 coupled to the base terminal of a transistor Q5, which has a collector terminal coupled to the base terminal of the second switching element Q2 of the first inverter 414. Similarly, the capacitor CD4 and the diac D10 are coupled to the base terminal of a transistor Q6, which has a collector terminal coupled to the base terminal of the switching element Q4 of the second inverter 416. In operation, the flux generated by the inductive elements L1′ and L1″ generates a voltage which charges the capacitor CD4. When the voltage on the capacitor CD4 rises above a predetermined threshold, the diac D10 triggers and the switching element Q5 and the switching element Q6 transitions to the conductive state (unless negatively biased by the respective control circuit 444 or 454). This effectively prevents the switching element Q2 of the first inverter from transitioning to the conductive state, thereby disabling the first inverter 414 or prevents the switching element Q4 of the second inverter from transitioning to the conductive state, thereby disabling the second inverter 416.

Similarly, the control circuit 454 is shown to include a resistor R51, a capacitor C51 and resistor R52 pair, a diode D51, a resistor R53, a capacitor C52, a diode D52, a resistor R54, a zener diode Z2, a diode D53 and a resistor R55. The resisters R51, R52 and R53 provide a voltage divider network 442 with diode D51 between the negative rail 441 and the junction between rectifying diodes D5 and D6 of the rectifier 410. The capacitor C51 in conjunction with resistor R52 provides a high frequency filter. The capacitor C52 is in parallel with resistor R53 and when an AC signal is present at AC input terminal 424a, diode D51 allows current to flow from the negative rail to the junction between diodes D5 and D6 of the rectifier 410 which in turn provides a negative voltage on capacitor C52 at the junction of the capacitor C52 and diode D51.

The junction between the capacitor C52 and diode D51 is connected in series with the diode D52, the resistor R54, the zener diode Z2, the diode D3 and the resistor R55 to the base of transistor Q6. In operation, when the negative voltage on the capacitor C52 rises above a predetermined threshold, the zener diode Z2 triggers and the switching element Q6 transitions to the non-conductive state. This effectively enables the second switching element Q4 of the second inverter to transition to the conductive state, thereby enabling the second inverter 416.

It should be appreciated that the zener diode Z1 is effective to provide a reference voltage to the gate of the switching element or transisitor Q6 to turn off transistor Q6 ensuring the inverter 416 is enabled.

It should be appreciated that the voltage divider network and series connected elements can be varied in a manner known in the art depending on the switching rates and necessary electrical characteristics required to properly bias the switching elements.

FIGS. 12A and 12B provide detailed circuit diagrams of a 110 volt implementation of the ballast 400 of FIG. 11. These detailed diagrams are depicted for illustrative purposes and are not intended to limit the scope of the invention.

It is understood that the number of lamps can vary without departing from the scope of the invention. For example, first and second lamps coupled in series can be energized independently from third and fourth lamps coupled in series across first and second terminals of an inverter. It is further understood that the signal paths used to couple the signal detection circuits and the lamp control circuits can include conductive pathways, optical couplings, inductive couplings, and other such connections known to one of ordinary skill in the art. In addition, one of ordinary skill in the art will readily appreciate that other types of switching elements can be substituted for those shown and described herein and that the particular circuit arrangements can be modified.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A ballast circuit receiving power from first and second independent ac input sources and independently energizing first and second lamps, comprising:
an inverter circuit providing an ac signal at a selected frequency across said lamps,
a rectifier receiving first and second input ac signals from said independent ac sources and applying an output DC signal to said inverter, and
a first bias circuit connected to said first input ac source and said first lamp, said first bias circuit detecting said first ac input signal and inhibiting application of the ac signal of the inverter to said first lamp when said first ac input signal is not present and permitting application of the inverter ac signal to said first lamp when said first ac input signal is present to selectively energize said first lamp independently of said second lamp.

2. A ballast circuit according to claim 1, further comprising
a second bias circuit connected to said second input ac source and said second lamp, said second bias circuit detecting said second ac input signal and inhibiting application of the inverter ac signal to said second lamp when said second ac input signal is not present and permitting application of the inverter ac signal to said second lamp when said second ac input signal is present, thereby selectively energizing said second lamp independently of said first lamp.

3. A ballast circuit according to claim 1, wherein said first bias circuit includes
a first detector connected to said first ac input source to provide a selected control signal when said first ac input signal is present, and
a first control circuit receiving said control signal and connecting said first lamp to said first ac input signal in response to said detection signal.

4. A ballast circuit according to claim 3, wherein said first detector emits a light signal optically coupled to said first control circuit when said first ac input signal s present.

5. A ballast circuit according to claim 4, wherein said first detector includes two light emitting diodes coupled in parallel and in opposite polarity.

6. A ballast circuit according to claim 4, wherein said first control circuit includes a first switching element configured to be activated into a conductive state in response to said light signal to permit application of the ac signal of the inverter to said first lamp.

7. A ballast circuit according to claim 6, further comprising a second switching element coupled to said first switching element such that a transition of said first switching element into a conductive state causes a transition of said second switching element into a conductive state, said conductive state of the second switching element providing a path for flow of current from said inverter to said first lamp during at least a portion of the ac signal of the inverter.

8. A ballast circuit according to claim 7, wherein said first switching element is an optically coupled transistor.

9. A ballast circuit according to claim 8, wherein said second switching element is a transistor.

10. A ballast circuit according to claim 9, further comprising a diode coupled in parallel with said second switching element such that said diode provides a path for flow of current from the inverter to said first lamp during a portion of the ac signal of the inverter.

11. A ballast circuit according to claim 9, wherein said optically coupled transistor includes a base terminal optically coupled to said light emitting diodes.

12. A ballast circuit according to claim 11, wherein said optically coupled transistor includes a collector terminal connected to a terminal of the first lamp.

13. A ballast circuit according to claim 12, wherein said optically coupled transistor includes an emitter terminal connected to a base terminal of said second switching element.

14. A ballast circuit according to claim 13, wherein said second switching element includes a collector terminal connected to a first terminal of said first lamp.

15. A ballast circuit according to claim 14, wherein said second switching element includes a an emitter terminal connected to an output terminal of said inverter.

16. A ballast circuit adapted for coupling to first and second ac sources and for independently energizing first and second loads, comprising
a rectifier circuit configured for coupling to said first and second ac input sources to receive first and second ac signals, said rectifier providing a DC output voltage across a positive and a negative rails when at least one of said first and second AC input signals is present,
a first inverter circuit connected across said positive and negative rails and adapted for coupling to said first load,
a second inverter circuit connected across said positive and negative rails and adapted for coupling to said second load, and
a first bias circuit coupled to said first inverter and having a signal path extending from said rectifier circuit thereto, said signal path providing a control signal indicative of the presence of said first ac signal, said first bias circuit enabling said first inverter to energize said first load when said first ac signal is present independent of whether said second ac signal is present.

17. A circuit according to claim 16, wherein said inverter circuit includes first and second switching elements and a first resonant inductive element, and a first capacitive element coupled between said first and second switching elements and said first load.

18. A circuit according to claim 17, wherein said bias circuit includes a third switching element having a conductive state and a non-conductive state and assuming said non-conductive state in response to said bias signal indicating the presence of said first ac signal to activate said first switching element into conduction to enable said first inverter.

19. A circuit according to claim 18, wherein said first, second and third switching elements are transistors.

20. A circuit according to claim 19, wherein said third switching element includes a collector terminal coupled to a base terminal of said first switching element, an emitter terminal coupled to said negative voltage rail and a base terminal coupled to a first terminal of a biasing capacitor, said biasing capacitor having a second terminal coupled to said negative voltage rail.

21. A circuit according to claim 20, wherein said first bias circuit includes a zener diode coupled between said signal path and the base terminal of said third switching element such that a control signal indicative of the presence of said first ac signal triggers said zener diode to cause a transition of said third switching element into a non-conductive state, thereby enabling said first inverter.

22. A circuit according to claim 21, wherein said bias circuit includes a capacitor coupled between said negative voltage rail and said signal path such that a voltage on said capacitor when said first ac signal is present triggers said zener diode to cause a transition of said third switching element into a non-conductive state.

23. A circuit according to claim 22, wherein said bias circuit further includes
a resistor connected in parallel to said capacitor, and
a rectifying diode coupled between said resistor and said rectifying circuit such that said rectifying diode is conductive during a selected half cycle of said first ac signal, if present, to provide a current from said negative rail through said resistor to the rectifier circuit.

24. A circuit according to claim 23, wherein said bias circuit further includes an AC filter coupled between said rectifying diode and said rectifier circuit.

25. A circuit according to claim 24, wherein said AC filter includes a capacitor coupled in parallel to a resistor.

26. A ballast circuit configured to receive power from first and second independent ac sources and to independently energize first and second loads, comprising
a rectifier circuit adapted to receive first and second AC signals from said first and second AC sources, respectively, said rectifier circuit providing a DC output voltage across a positive rail and a negative rail when at least one of said first and second AC signals is present,
first and second inverter circuits for energizing said first and second loads, respectively, each of said inverter circuits being connected across said positive and negative rails,
a first control circuit coupled to the first inverter circuit for normally disabling said inverter circuit and enabling said first inverter circuit when said first AC signal is present to energize said first load regardless of the presence of said second AC signal, and
a first signal path extending from said rectifier circuit to said first control circuit for transmitting said first AC signal to said first control circuit.

27. A ballast circuit according to claim 26, further comprising
a second control circuit coupled to said second inverter circuit, said second control circuit enabling said second inverter circuit when said second AC signal is present to energize said second load regardless of the presence of said first AC signal, and
a second signal path extending from said rectifier to circuit to said second control circuit for transmitting said second AC signal to second control circuit.

28. A ballast circuit according to claim 26, wherein said first inverter circuit includes first and second switching elements coupled to each other in a half bridge configuration.

29. A ballast circuit according to claim 28, wherein said first control circuit includes a third switching element coupled to said first switching element, said third switching element transitioning to a conductive state when said first AC signal is present to activate said first switching element, thereby energizing said first inverter.

30. A ballast circuit according to claim 29, wherein said first control circuit further includes a fourth switching element coupled to said first and third switching elements, said fourth switching element being in a conductive state in absence of said first AC signal to prevent said first switching element from transitioning to a conductive state, said third switching element causing a transition of said fourth switching element from a conductive state to a non-conductive state when said first AC signal is present.

31. A ballast circuit according to claim 30, wherein said first, third and fourth switching elements are transistors.

32. A ballast circuit according to claim 31, wherein said first control circuit further includes a first enable capacitor coupled between a base terminal and an emitter terminal of said third switching element.

33. A ballast circuit according to claim 32, wherein said first control circuit further includes an enable diode coupled within said first signal path and coupled at one end to said first enable capacitor such that said enable diode transitions to a conductive state when said first AC signal is present to charge up said first enable capacitor.

34. A ballast circuit according to claim 33, wherein said first control circuit further includes a zener diode coupled between said first enable capacitor and the base terminal of said third switching element such that when the charge on said first enable capacitor exceeds a selected threshold when said first AC signal is present said zener diode transitions to a conductive state to trigger said third switching element into conduction.

35. A ballast circuit according to claim 34, wherein said first control circuit includes a first resistor couple between the base terminal and the emitter terminal of said third switching element such that it provides a path for current flow when said zener diode transitions to a conductive state.

36. A ballast circuit according to claim 35, wherein said first control circuit further includes a second resistor connected between said enable diode and said zener diode.

37. A ballast circuit according to claim 36, wherein said first control circuit further includes a second enable capacitor coupled between a base terminal and an emitter terminal of said first switching element, said second enable capacitor biasing said first switching element into conduction when a charge thereon exceeds a threshold.

38. A ballast circuit according to claim 37, further comprising a resonant inductive element coupled from a junction between said first and second switching elements and said load.

39. A ballast circuit according to claim 38, wherein said first control circuit further includes
a third resistor coupled at a first end to the base terminal of said first switching element and having a second end, and
an inductive element coupled at one end to the second end of the resistor and at another end to the emitter terminal of said transistor, said inductive element being inductively coupled to said resonant inductive element.

40. A ballast circuit according to claim 39, wherein said fourth switching element includes a collector terminal, a base terminal, and an emitter terminal, said collector terminal being coupled to the first end of said third resistor.

41. A ballast circuit according to claim 40, wherein said first control circuit further includes a fourth resistor coupled between the emitter terminal of said fourth switching element and the emitter terminal of said first switching element.

42. A ballast circuit according to claim 41, wherein said first control circuit further includes a third enable capacitor coupled between the base terminal of the fourth switching element and the negative voltage rail to bias said fourth switching element into conduction when a charge thereon exceeds a threshold.

43. A ballast circuit according to claim 42, wherein said first control circuit further includes a diac coupled between the base terminal of said fourth switching element and the second terminal of said of said third resistor.

44. A ballast circuit according to claim 43, wherein said first control circuit further includes a fifth resistor coupled in parallel to said diac.

45. A ballast circuit according to claim 44, wherein said first control circuit further includes a sixth resistor connect to a seventh resistor in series at a junction, the combined series circuit of the sixth and the seventh resistors being coupled in parallel to said diac.

46. A ballast circuit according to claim 45, wherein a collector terminal of said third switching element is connected to the junction between said sixth and seventh resistors.

47. A ballast circuit according to claim 26, further comprising first, second, and third input terminals, said first and second input terminals being configured to couple to said first AC input source and said second and third input terminals being configured to couple to said second AC source.

48. A ballast circuit according to claim 47, wherein said rectifier includes six diodes configured in three parallel groups, each group having two diodes connected end-to-end, said first terminal being connected to a connection point of the diodes of a first of said groups, said second terminals being connected to a connection point of the diodes of a second said groups, and said third terminal being connected to a connection point of the diodes of a third of said groups.

49. A circuit for energizing first and second loads, comprising:
first, second, terminals and a common terminal adapted to receive input AC power from two independent AC sources, said first and common input terminals adapted to receive a first AC input signal from one source and said second and common input terminals adapted to receive a second AC input signal from the other source,
a first rectifier coupled to said first and second input terminals to receive said first AC signal to produce a first DC signal,
a first inverter circuit coupled to said first rectifier to receive said first DC signal and to provide an AC signal for energizing the first lamp,
a second rectifier coupled to said second and third terminals to receive said second AC signal and to provide a second DC output signal,
a second inverter circuit coupled to said second rectifier to receive said second DC signal and to provide an AC signal for energizing said second lamp,
a disable circuit coupled to said first inverter and responsive to a signal imbalance between said first and common terminals to disable said first inverter when said first AC input signal is not present and said second AC input signal is present.

50. The circuit of claim 49, further comprising
a first inductor coupled to said first terminal, and
a second inductor coupled to said common terminal, wherein said first and second inductors are inductively coupled to one another.

51. The circuit of claim 50, wherein said first inverter disable circuit includes a third inductor inductively coupled to said first and second inductors.

52. The circuit of claim 51, wherein said first and second inductors are configured such that each substantially cancels a magnetic flux in the other when said first signal is present.

53. The circuit of claim 52, wherein said first and second inductors are configured to induce a voltage across said third inductor when said first AC signal is not present and said second AC signal is present.

54. The circuit of claim 53, wherein said first inverter disable circuit includes a diode connected in series to said third inductor to rectify the signal induced in said third inductor.

55. The circuit of claim 54, wherein said first inverter includes two switching elements coupled to one another in a half bridge configuration.

56. The circuit of claim 55, wherein said first inverter disable circuit includes one switching element coupled across at least one of the switching elements of the inverter such that a conduction of the switching element of said first disable circuit disables the inverter.

57. The circuit of claim 56, wherein said first inverter disable circuit further includes a first capacitor coupled across the series combination of said third inductor and said diode such that a signal induced in said third inductor causes a charging up of said first capacitor.

58. The circuit of claim 57, wherein said first inverter disable circuit further includes a second capacitor coupled across said switching element of the first disable circuit such that a pre-determined charge on said second capacitor causes a transition of said switching element of the first disable circuit from a nonconductive state to a conductive state.

59. The circuit of claim 58, wherein said first inverter disable circuit further includes a diac coupled between said first and second capacitors such that a voltage across said first capacitor exceeding a pre-determined threshold triggers said diac to cause a charging up of said second capacitor,
wherein the charging up of said second capacitor produces a voltage across said capacitor that triggers the switching element of said first disable circuit into conduction.
